(19) United States
(12) Patent Application Publication
(10) Pub. No.: US 2008/0235273 A1
(43) Pub. Date: Sep. 25, 2008

(54) Automatic multi-cursor management

(76) Inventor: Yuly Shipilevsky, Toronto (CA)

Correspondence Address: YULY SHIPILEVSKY;APT 1108, 370 RIDELLE AVENUE, TORONTO, ON, M6B 4B4, CA

(21) Appl. No.: 11/635,627

(22) Filed: Dec. 8, 2006

(51) Int. Cl. G06F 3/038; G06F 17/30

(52) U.S. Cl. 707/103 Y; 710/16; 707/E17.014; 707/E17.055

(57) ABSTRACT

The present invention provides an executable program loaded in the computer memory as a process and periodically automatically polling computer's communication ports to identify pointing devices coupled to the computer via the corresponding communication ports, managing a set of views of the file-mapping objects of the corresponding conventional cursor driver files mapped to the program process's virtual address space to support simultaneously a plurality of cursors independently controlled by the corresponding pointing devices.

### BACKGROUND OF THE INVENTION

This invention relates to multi-cursor multi-pointing device management, and more specifically to the computer program and method for automatic multi-cursor multi-pointing device management.

There are many kinds of collaborative activities, where multiple users would like to have a possibility to use simultaneously multiple pointing devices coupled to the same computer to control multiple cursors, displayed on the same Visual Display Unit(VDU) or on different VDUs coupled to that computer, wherein each cursor is associated with respective pointing device: meetings, brainstorm sessions, conferences, presentations, classroom lessons, etc. Proliferation of Universal Serial Buses(USB) providing multiple communication ports and wireless(e.g., Blue Tooth) means favor the development of the multi-cursor multi-pointing device technologies.

Each or single user may use several pointing devices, coupled to the same computer and simultaneously manipulate of several different respective cursors by hands, fingers, feet. Each user may sit in his/her cubicle, room, view his/her VDU, coupled to the same computer and manipulate simultaneously of multiple cursors by respective pointing devices coupled to said same computer to implement collaborative or individual work.

There are several approaches in the previous art to provide a multi-cursor multi-pointing device control.

According to the first approach, a Single Display Groupware applications are developed that implement a multi-cursor multi-pointing device control(J. Stewart, B. B. Bederson, & A. Druin, “Single Display Groupware: A Model for Co-Present Collaboration.”, Proceedings of ASM CHI99 Conference on Human Factors in Computing Systems, 286293, 1999). The most advanced applications are written as a Java platform independent packages. The major drawback of said applications is a usability restriction: the multi-cursor multi-device control is applicable to these applications only.

The second and third approaches are exclusively based on creating multiple cursors using cursor driver files instead of applications that support multiple pointing devices or multiple cursor presentations. These two approaches are free from the mentioned above drawback of the first approach.

According to the second approach a non-conventional cursor driver file is developed that supports multiple cursors, each one controlled by the respective mouse.

According to the third approach(U.S. Pat. No. 5,917,472) each of a plurality of cursors displayed at the same screen and independently controlled by the respective pointing device(mouse) each one connected to the same computer, is created using separately loaded instance of a conventional cursor driver file, since a single instance of a conventional cursor driver file can support only a single cursor controlled by the respective pointing device, coupled to the computer via the respective communication port. A single instance of a conventional cursor driver file cannot serve simultaneously more than one pointing devices, coupled to the same computer via respective different communication ports.

When user manipulates by the pointing device, the corresponding cursor positioning signals are being issued to the computer.

A conventional cursor driver file receives these signals and translates them into signals, the computer uses to present the cursor a new location. When the pointing device, sends data to the communication hardware (communication port), the communication hardware interrupts any program, executed by computer's Central Processing Unit and passes control to the conventional cursor driver file. The conventional cursor driver file processes the data and returns control to the interrupted program(U.S. Pat. No. 6,137,472). The cursor driver for the cursor positioning signals operates by periodically interrupting the computer system to check(by the listener) whether the pointing device indicates a new position, and if so, the magnitude of any change.

This is believed to be well within the scope of the skilled artisan and no further description of the conventional cursor driver file is believed necessary.

Wide proliferation of conventional cursor drivers files determines and emphasizes their preferences.

The major drawback of the third approach, described in U.S. Pat. No. 5,917,472, is a necessity to create a new process in memory, each time a new instance of cursor driver file is separately loaded into the memory to support the corresponding independent cursor image. It means that, for example, if it is necessary to provide 50 independent cursors, according to the U.S. Pat. No. 5,917,472, it would be separately loaded 50 instances of cursor driver files, wherein each instance is run in their separate process in the memory(50 new processes/threads) which is inefficient.

File mapping(memory-mapped files) is known as a highly efficient mechanism for file's instances' creation. File mapping is the association of a file's contents with a portion of the virtual address space of a process. A process can create(map) into a physical memory a file-mapping object of any file, stored on disk and any process then can map file views of this file-mapping object into virtual address space of that process. Processes read from and write to the file view using pointers thus easily and efficiently access and share data. If a user runs two copies of a program, it is clearly inefficient for Operating System(OS) to have two identical copies of the same executable image in memory. Virtual Memory Manager (VMM) of OS only loads a single copy(file-mapped object) of a binary executable file into memory and when a new process is created for an application that is already running, VMM simply maps another memory-mapped view of the file-mapping object that identifies the executable file and creates a new process object and a new thread object. By using file mapping(memory-mapped files), multiple running instances of the same application can share the same code and data in memory: this is why load second instances is quicker since the code and unwritten data page frames exist in physical memory already. A process can use a set of file mapping functions to create file-mapping objects and file views. For example, in Microsoft Windows OS, the following Win32 functions can be used: “OpenFileMapping”, “CreateFileMapping”—to open and create file-mapping objects, “MapViewOfFile”—to map a view of a file-mapping object into the address space of a calling process, “UnmapViewOfFile”—to unmap a mapped view of a file from calling process's address space, “CloseHandle”—to close file-mapping object. Additonal information on file mapping can also be obtained at: “http ://msdn.microsoft.c.om/library/default.asp?url=/library/en-us/dngenlib/html/msdn_manamemo.asp”.

Since creating a plurality of cursor driver file's instances via loading (running) of each instance as a separate process waste computer resources, there is a need to allow multiple pointing devices, coupled to the same computer be simultaneously served by respective instances of respective conventional cursor drivers' files for creating the corresponding independent cursors, instances, altogether associated with and affected by a single process only and there is a need to detect changes in pointing devices' coupling /uncoupling to the computer via computer's communication ports and rebuild/update respectively a set of conventional cursor drivers files' instances to serve changed set of coupled pointing devices.

### BRIEF SUMMARY OF THE INVENTION

The present invention provides an executable program loaded into the computer's memory as a process. Upon loading, the program—Conventional Cursor Driver Files' Views Management Program(CCDFVMP), automatically and periodically polls computer's communication ports to identify pointing devices, currently coupled to the computer via the respective communication ports. During each poll cycle, all communication ports are being polled. Poll cycles are executed continuously with a time delay between each two consecutive poll cycles. During each poll cycle, for each communication port being polled, CCDFVMP identifies whether a pointing device is coupled to the port. If a pointing device is coupled to the port, CCDFVMP identifies the type of the pointing device, temporarily saves the data, identifying the identified port and the type of the pointing device and verifies, whether a Conventional Cursor Driver Files' Views Management Database(CCDFVMD) exists. CCDFVMD is being created by CCDFVMP via Database Management System (DBMS) and CCDFVMP is connecting to CCDFVMD via DBMS to store and exchange data efficiently.

CCDFVMD comprises at least Communication Ports—Coupled Pointing Devices Relations Table(CPCPDRT) and Existing File-Mapped Objects Table(EFMOT). Each row of CPCPDRT comprises at least one column, identifying a communication port, at least one column identifying a type of the pointing device, coupled to the computer via that communication port and at least one column, identifying a view, mapped by CCDFVMP against that pointing device (e.g. a column, containing a pointer, returned by the function “MapViewOfFile” or “MapViewOfFileEx”).

Each row of EFMOT comprises at least one column identifying a type of pointing device and at least one column identifying a file-mapping object (e.g. a column, containing a handle to the file-mapping object, returned, e.g., by the function “CreateFileMapping”), created to serve any coupled pointing device of of said respective type by creating/mapping the corresponding file views of said file-mapping object. If CCDFVMD does not exist, CCDFVMP creates CCDFVMD and at least CPCPDRT and EFMOT. If CCDFVMD does exist, CCDFVMP accesses CCDFVMD, querying CPCPDRT using the port-identifying columns as a primary key and using the data, identifying currently polled identified port(the data, temporarily saved) to retrieve a row, containing the data of the type of the pointing device that was coupled to the currently polled identified port—the data, obtained and recorded/confirmed during pervious poll cycle or cycles(some cycles could be interrupted due to interruption of CCDFVMP).

If no row for said query (querying CPCPDRT) is retrieved, CCDFVMP querying EFMOT(using the columns, identifying the type of pointing device as a primary key and using the data, identifying the type of identified pointing device coupled to the currently polled identified port, the data, temporarily saved), to retrieve a row, containing the data, identifying a file-mapped object, existing to serve any pointing device of the type, identified as coupled to the currently polled port. If no row for said query(querying EFMOT) is retrieved, CCDFVMP, using the appropriate file mapping-related functions creates file-mapping object of the respective conventional cursor driver file and maps its view into program's virtual address space, so, that against the pointing device, coupled to the computer via the polled port, a corresponding view is being mapped, the corresponding row is being inserted/created into CPCPDRT and the corresponding row is being inserted/created into EFMOT, temporarily saved data is deleted and the next port is being polled or poll cycle is finished. If the corresponding row for said query (querying EFMOT) is retrieved, CCDFVMP, using values stored in columns, identifying the corresponding file-mapped object(if it exists), e.g., a handle to the corresponding file-mapped object, maps its view into CCDFVMP's virtual address space, so, that against the pointing device, coupled to the computer via the polled port, a corresponding view is being mapped, the corresponding row is being inserted/created into CPCPDRT, deletes temporarily saved data and next port is being polled or poll cycle is finished. If the corresponding row for said query (querying CPCPDRT) is retrieved, CCDFVMP compares the data, identifying the type of identified pointing device coupled to the currently polled identified port(the data, temporarily saved) with the data of the type of pointing device stored in respective columns of the retrieved row.

If compared types are identical, CCDFVMP verifies whether the corresponding view exists—if yes, deletes temporarily saved data and next port is being polled or poll cycle is finished, if no—the mentioned above steps regarding querying EFMOT are issued to map/create the corresponding view and update (instead of insert/create a new row) the columns (identifying mapped view) retrieved CPCPDRT's row with the corresponding values, temporarily saved data is deleted and next port is being polled or poll cycle is finished. If the types are different—a view, matched to the port is unmapped (if exists), the mentioned above steps regarding querying EFMOT are issued to map/create the corresponding view and update (instead of insert/create a new row) the columns, identifying the type of coupled pointing device with the corresponding values(temporarily saved) and update the columns identifying mapped view of retrieved CPCPDRT's row with the corresponding values temporarily saved data is deleted and next port is being polled or poll cycle is finished. (It is supposed that pointing devices of different types can be served only by the corresponding instances of conventional cursor drivers' files of different types as well). If no pointing devices are coupled, to the currently polled port, CCDFVMP temporarily saves the data, identifying currently polled port, and verifies, whether the CCDFVMD exists. If CCDFVMD does not exist, temporarily saved data is deleted and next port is being polled or poll cycle is finished. If CCDFVMD does exist, CCDFVMP accesses CCDFVMD, issues a query, querying CPCPDRT using port-identifying columns as a primary key and the data, identifying currently polled identified port (temporarily saved data) to retrieve a row, containing the data regarding the type of the pointing device, coupled to the currently polled identified port, the data, obtained and recorded/confirmed during pervious poll cycle or cycles. If no row is retrieved, temporarily saved data is deleted and the next port is being polled or poll cycle is finished. If the row is retrieved, CCDFVMP unmaps the view(if exists) of file-mapping object of the conventional cursor driver file respective to a pointing device coupled to the currently polled port during previous poll cycle or cycles, deletes retrieved row, deletes temporarily saved data, and next port is being polled or poll cycle is finished.

When the poll cycle is finished, CCDFVMP issues a query, querying both CPCPDRT and EFMOT, wherein for each row in EFMOT the corresponding rows CPCPDRT, having the same content in columns, identifying the type of coupled pointing device(primary key in EFMOT and foreign key in CPCPDRT) are being retrieved. If for some row in EFMOT no respective row in CPCPDRT is retrieved(no pointing devices of such type are coupled), the corresponding file-mapping object is closed if exists (by, e.g., “CloseHandle” function, using a handle, stored in said some row in EFMOT, identifying the file-mapping object) and said some row in EFMOT is being deleted as obsolete and redundant.

Such matching (coupled pointing device—port—appropriate view) does not mean, that the pointing device will obligatory communicate with an instance (represented by a view) mapped against it. However, such matching guarantees a correct total balance of coupled pointing devices vs. the corresponding views.

As a result of each poll cycle, each coupled pointing device is provided with a mapped view of file-mapping object of the appropriate conventional cursor driver file for simultaneous communicating (one pointing device with one respective view) and creating multiple cursors, simultaneously controlled by the respective pointing devices(one pointing device—one port—one view—one cursor).

CCDFVMP's above-described logic includes the cases, when CCDFVMP was reloaded(restarted), after it was stopped or interrupted, whereas CCDFVMD and its objects already were created/updated. In these cases, despite CPCPDRT rows are existed upon CCDFVMP reloading(restarting), the corresponding views, mapped to the CCDFVMP's virtual address space (before it was stopped or interrupted) should be unmapped by OS as a result of CCDFVMP's stopping or interruption, as well as CCDFVMP's above-described logic includes the cases, when, the computer, where CCDFVMP is running, was restarted, and therefore, all file-mapped objects(having the corresponding rows in EFMOT) were closed.

Optionally, a configuration file, containing values of the configuration parameters, e.g., the value of a time delay between two consecutive poll cycles, number of poll cycles, etc., can be loaded/processed by CCDFVMP upon CCDFVMP's loading.

CCDFVMD can be (optionally) created or/and accessible/supported(read/write) by the external applications/users as well before and after CCDFVMP's loading.

### BRIEF DESCRIPTION OF THE DRAWINGS

FIG. 1 is a block diagram depicting one embodiment of the present Conventional Cursor Driver Files' Views Management Program.

FIGS. 2A-2H depict a high level flow chart illustrating the automatic Conventional Cursor Driver Files' Views Management by Conventional Cursor Driver Files' Views Management Program loaded in computer's memory as a process.

FIGS. 3A-3B illustrate diagrams, which show an example of Communication Ports—Coupled Pointing Devices Relations Table and an example of Existing File-Mapped Objects Table.

### DETAILED DESCRIPTION OF THE INVENTION

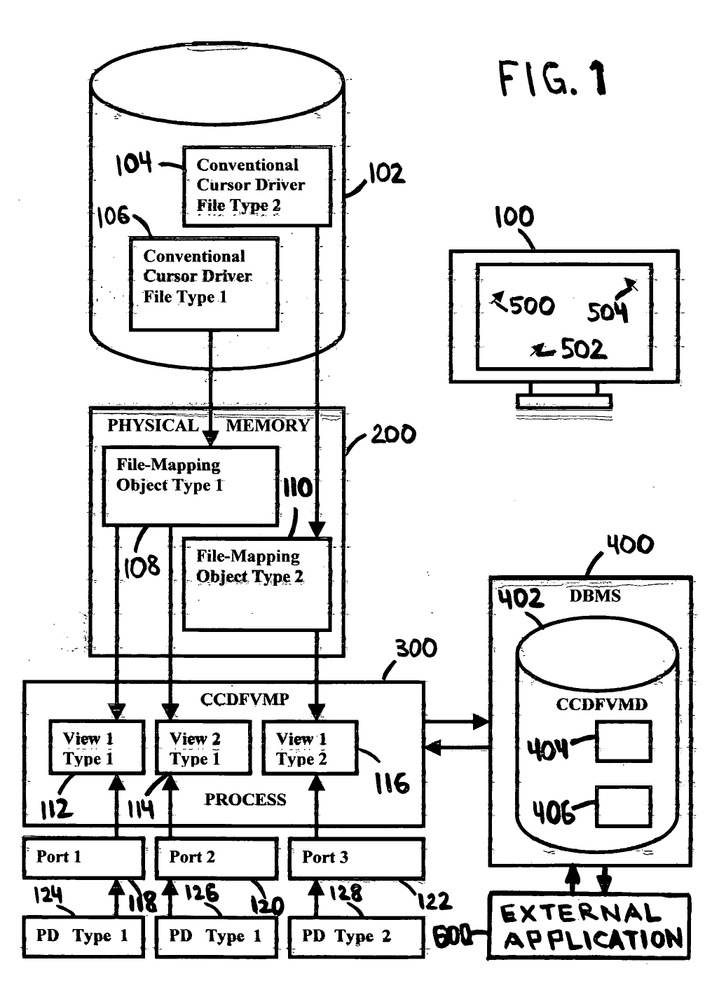

FIG. 1 shows a block diagram depicting one embodiment of the present Conventional Cursor Driver Files' Views Management Program(CCDFVMP).

This figure shows CCDFVMP loaded as a process 300 and the objects, created by and/or interacted with CCDFVMP while it provides the automatic management of a set of views, mapped into process's 300 virtual address space, the set includes the views 112, 114 of the file-mapping object 108 of the conventional cursor driver file 104 and includes a view 116 of the file-mapping object 110 of the conventional cursor driver file 106, (file-mapping objects 108 and 110 are created and stored in computer's physical memory 200, conventional cursor driver files 104 and 106 are stored on the disk drive 102), the set, simultaneously serving a set of pointing devices (type 1)124, 126, and (type 2) 128, currently coupled to the same computer via respective communication ports 118, 120, 122 to control respective independent cursors 500, 502, 504, displayed at the display 100, coupled to the computer.

CCDFVMP periodically polls computer ports to identify each of a plurality of pointing devices, coupled to the computer or to detect each port that is uncoupled to any pointing device; in response to identifying each of a plurality of pointing device coupled to the computer and in response to detecting each of computer's port, which is uncoupled to any pointing device, CCDFVMP compares obtained identifying and detecting information with the respective information obtained during previous poll cycle(s) and stored in a special database, and on the base of that comparison, respectively rebuild/update said set of views, in case if any changes in number, types, coupling/uncoupling status of pointing devices' set are detected. During each poll cycle, all communication ports are being polled. Poll cycles are executed continuously with a time delay between each two consecutive poll cycles.

During ports' polling, CCDFVMP interacts(retrieves/creates/update the data) with Conventional Cursor Driver Files' Views Management Database(CCDFVMD) 402 via Database Management System(DBMS) 400. CCDFVMD 402 can be (optionally)created or/and accessible/supported(read/write) by external applications or users 600 as well, before and after CCDFVMP's loading(as well as immediately created upon CCDFVMP's loading).

A database is a collection of data stored on disk in some organized fashion. The database is the container, created and manipulated via DBMS. A table (in a database) is a structured file(list of data) that can store data of specific type. Tables are made up of one or more columns. A column contains a particular piece of information within a table. Data in a table is stored in rows—each record saved is stored in its own row. Envisioning a table as a spreadsheet style grid, the vertical columns of the grid are the table columns, and the horizontal rows are the. table rows. Every row in a table should have some column(or set of columns) that uniquely identifies it. A column(or set of columns) that uniquely identifies every row in a table is called a primary key. The primary key is used to refer to a specific row. A foreign key is a key column(field) that identifies records in a table, by matching a primary key in a different table. Databases are highly efficient to store and exchange data.

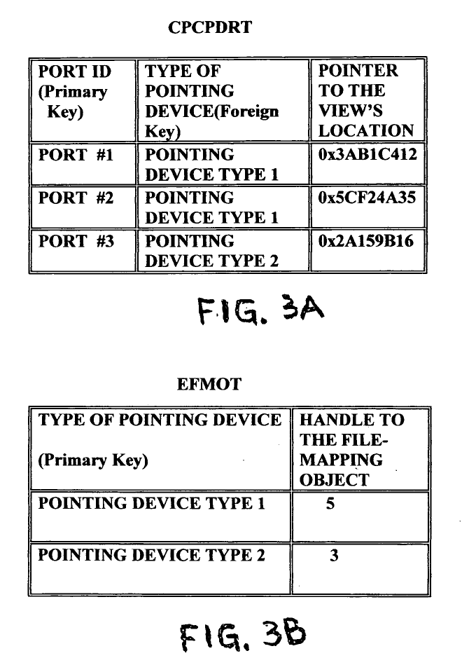

Structured Query Language(SQL) is a language designed specifically for communicating with databases and provides a simple and efficient way to read and write data from a database. Almost every major DBMS supports SQL. Applications can communicate with databases via unified database access framework: ActiveX Data Objects(ADO), ADO.NET, Object-Linking and Embedding Database(OLE DB), Object Database Connectivity(ODBC). CCDFVMD comprises at least Communication Ports—Coupled Pointing Devices Relations Table(CPCPDRT) 404 and Existing File-Mapped Objects Table(EFMOT) 406. FIG. 3A illustrates a diagram, which shows an example of CPCPDRT and FIG. 3B illustrates a diagram, which shows an example of EFMOT.

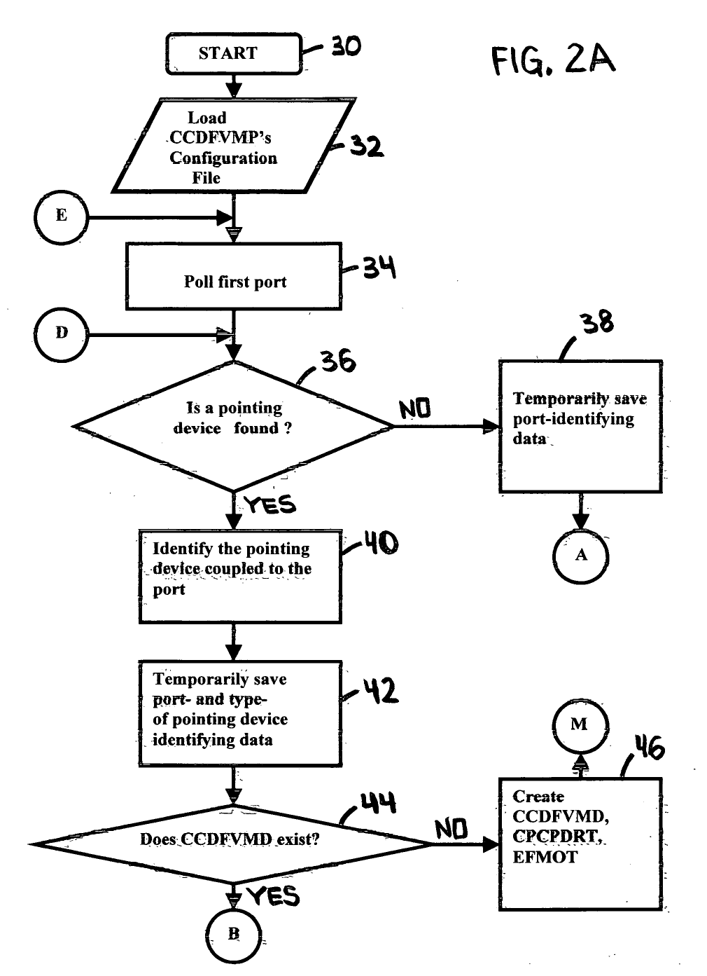

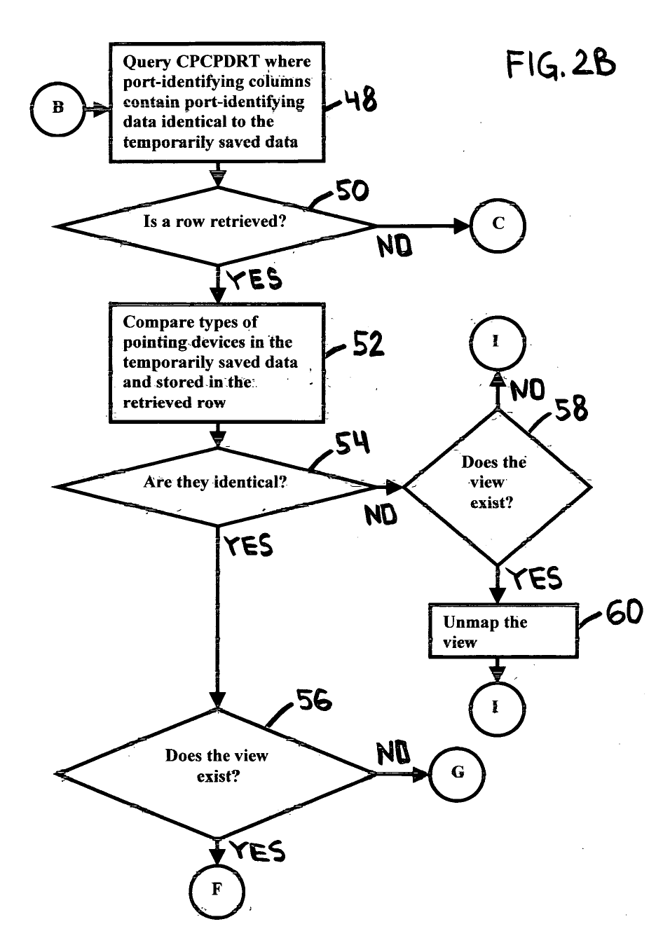

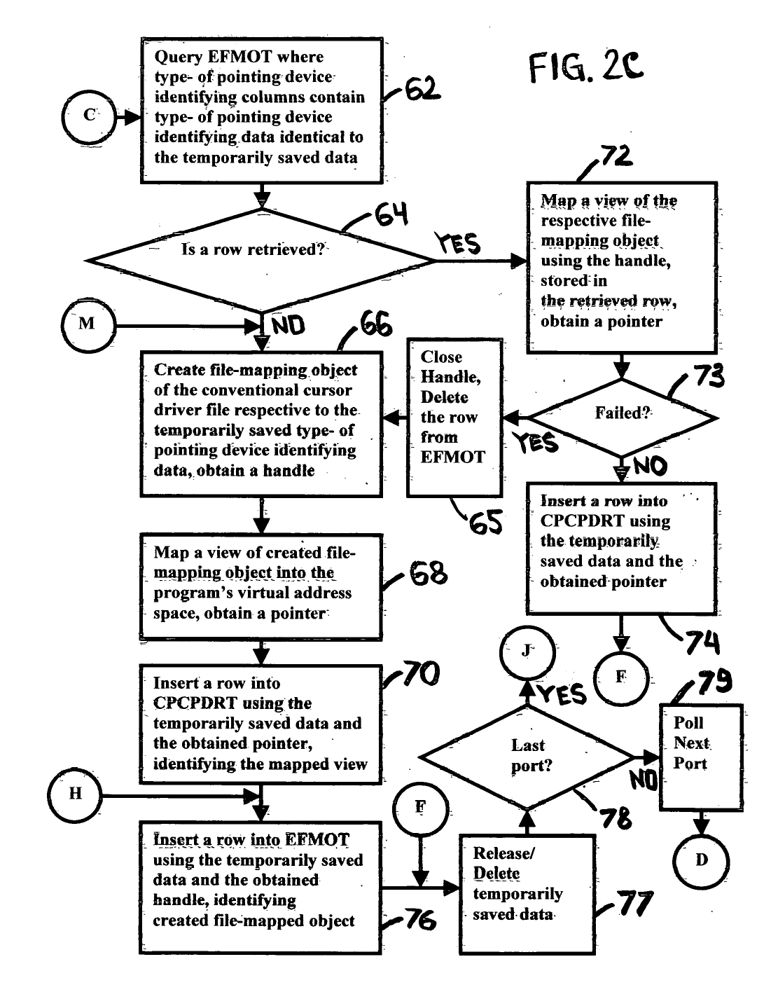

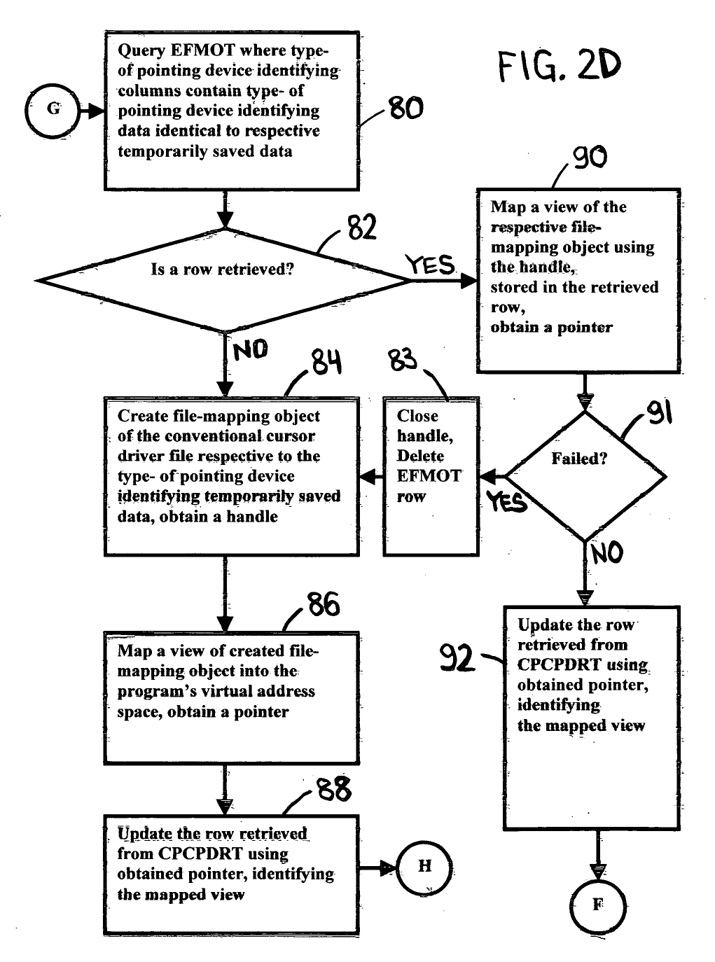

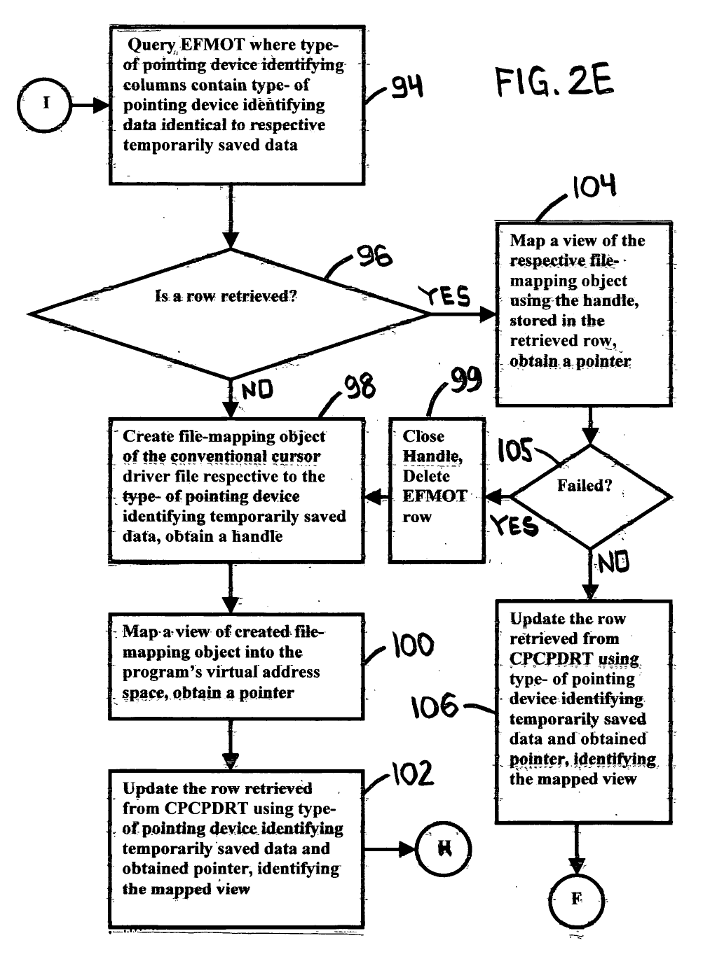

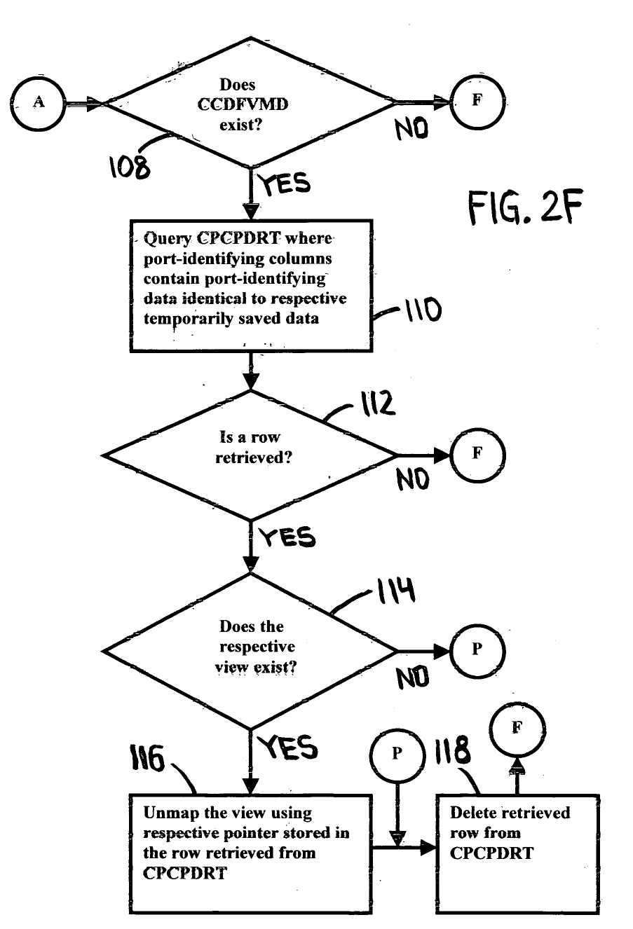

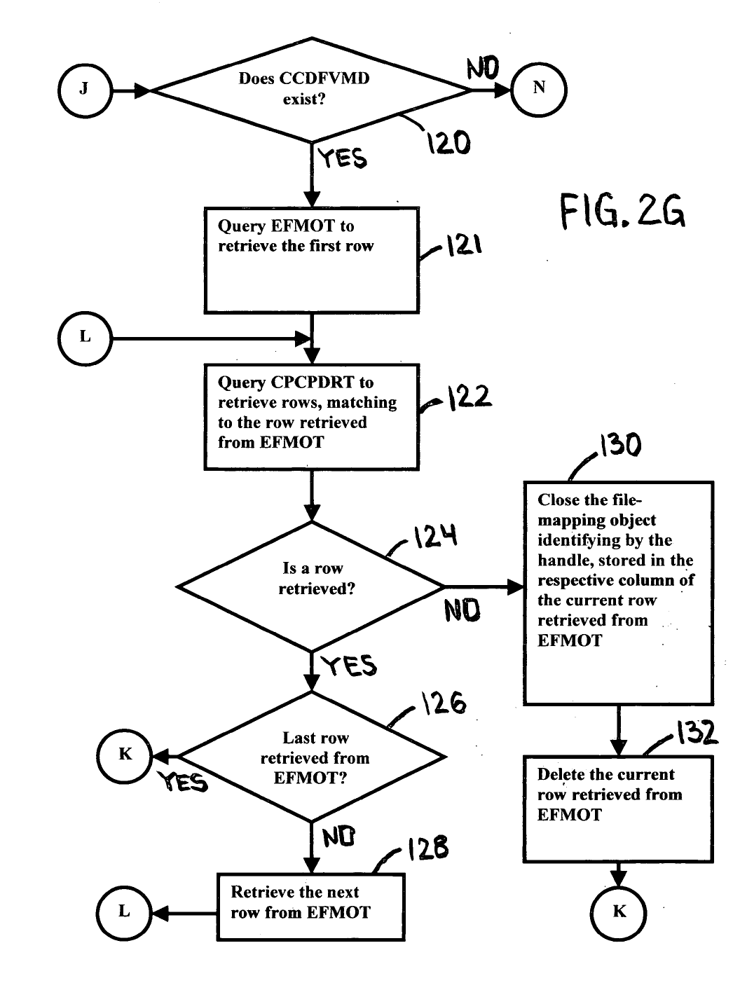

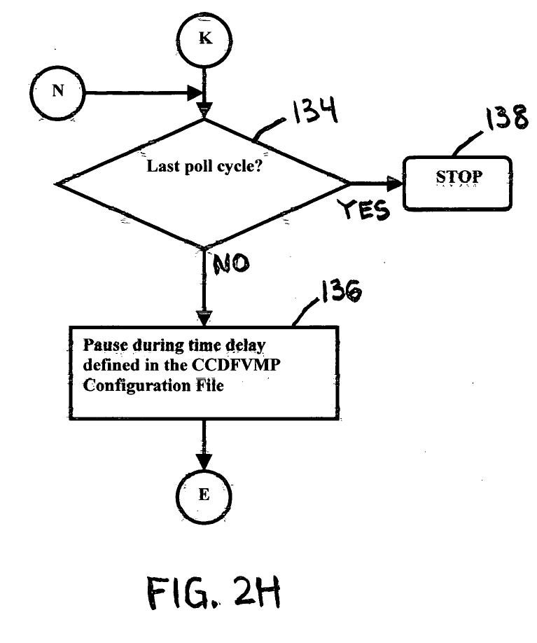

Each row of CPCPDRT comprises at least one column, identifying a communication port, at least one column identifying a type of the pointing device, coupled to the computer via that communication port and at least one column, identifying a view, mapped by CCDFVMP against that pointing device (e.g. a column, containing a pointer to the view's location in the CCDFVMP's process virtual address space, returned ,e.g., by the function “MapViewOfFile” or “MapViewOfFileEx”). Each row of EFMOT comprises at least one column identifying a type of pointing device and at least one column identifying a file-mapping object (e.g. a column, containing a handle to the file-mapping object—an index in the CCDFVMP process's Handle Table, a table, containing information about Kernel Objects, a handle, returned, e.g., by the function “CreateFileMapping”) of the respective conventional cursor driver file, the file-mapping object, created to serve any of coupled pointing devices of said respective type by creating/mapping the corresponding file views of said file-mapping object(one view serves one coupled pointing device only). With reference now to FIGS. 2A-2H, there is depicted a high level flow chart which illustrates Conventional Cursor Driver Files' Views Management by CCDFVMP, loaded in computer's memory as a process.

The program begins at block 30 and thereinafter passes to block 32, which depicts loading of the CCDFVMP's Configuration File, containing the value of a time delay between two consecutive poll cycles. Thereafter, CCDFVMP passes to block 34 which depicts polling of some first port of the computer, where CCDFVMP is loaded/running.

Next, block 36 illustrates determination of whether or not a pointing device was found during polling of currently polled port. If a determination is made that a pointing device is found, CCDFVMP identifies coupled pointing device(block 40) and temporarily (until next port will be polled) saves port- and type- of pointing device identifying data, e.g., in a variables, data structures or files (block 42). Next, CCDFVMP verifies, whether CCDFVMD exists(block 44). If CCDFVMD exists, CCDFVMP querying CCCPDRT to retrieve a row, where port-identifying columns(primary key) contain the data, which is identical to the port-identifying(currently polled port) temporarily saved data(block 48). Next, CCDFVMP verifies, whether a row is retrieved(block 50). If no row retrieved—currently polled port was uncoupled during previous poll cycle(s), CCDFVMP querying EFMOT to retrieve a row, where type- of pointing device identifying columns(primary key) contain the data, which is identical to the type- of pointing device identifying data stored in the temporarily saved data(block 62). Next, CCDFVMP verifies, whether a row is retrieved(block 64). If no row is retrieved(block 66), CCDFVMP creates a file-mapping object of found conventional cursor driver file respective to the type- of pointing device identifying temporarily saved data(block 66) and obtains a handle to the created file-mapping object. Next, CCDFVMP, using obtained handle, maps a view of the created file-mapped object into CCDFVMP's virtual address space and obtains a pointer to the view's location in the CCDFVMP's process virtual address space(block 68). Next, CCDFVMP inserts a row into CPCPDRT, using currently polled port- and type- of coupled pointing device identifying temporarily saved data and the obtained pointer, identifying the mapped view of the respective conventional cursor driver file(block 70). Next, CCDFVMP inserts a row into EFMOT using type- of pointing device identifying temporarily saved data and obtained handle to the created file-mapping object(block 76). Next, CCDFVMP releases/deletes temporarily saved data(block 77). Next block 78 illustrates a determination, whether or not currently polled port is a last polled port. If a determination is made that currently polled port is not a last polled port, next port is being polled(block 79) and CCDFVMP then passes back to block 36. If a determination is made that last port has been polled, next block 120 illustrates a determination, whether CCDFVMD exists. If a determination is made, that CCDFVMD does not exist, CCDFVMP then passes to block 134 which illustrates determination, whether or not current poll cycle is a last cycle. If a determination is made that last poll cycle has been executed, then CCDFVMP is terminated(block 138). If a determination is made that currently executed poll cycle is not the last poll cycle, then CCDFVMP pausing during a delay time defined in the CCDFVMP's Configuration File(block 136) and CCDFVMP passes back to block 34 to start next poll cycle. Referring again to block 120, If a determination is made that CCDFVMD does exist, CCDFVMP then passes to block 121 and CCDFVMP querying EFMOT to retrieve the first row from EFMOT. Next, CCDFVMP querying CPCPDRT to retrieve rows that match to the row retrieved from EFMOT(using columns, identifying type of pointing devices—a primary key in EFMOT and a foreign key in CPCPDRT). CCDFVMP then passes to block 124 which illustrates determination, whether or not a row is retrieved from CPCPDRT. If a determination is made that no row is retrieved from CPCPDRT, then CCDFVMP closes the file-mapping object, identified by the handle, stored in the row retrieved from EFMOT (block 130), deletes those row retrieved from EFMOT as obsolete and redundant(block 132) and passes to block 134. Referring again to block 124, if a determination is made that a row is retrieved from CPCPDRT, CCDFVMP then passes to block 126 which illustrates determination, whether or not the last row is retrieved from EFMOT. If a determination is made that the last row from EFMOT has been retrieved CCDFVMP passes to block 134. If a determination is made that the last row is not retrieved, CCDFVMP retrieves the next row from EFMOT(block 128) and passes back to block 122. Referring again to block 64, if a determination is made that a row is retrieved from EFMOT, CCDFVMP is trying to map a view of the respective file-mapping object using the handle, stored in the retrieved row to obtain a pointer to the view's location in the CCDFVMP's process virtual address space(block 72). Next, CCDFVMP passes to block 73 which illustrates determination, whether or not the mapping has been failed, e.g., because the corresponding file-mapping object is no longer exist(e.g., due to computer's restart). If a determination is made that view mapping has been failed, CCDFVMP closes the handle of the corresponding file-mapping object(if its exist) deletes retrieved row from EFMOT(block 65) and passes to block 66, described above. If a determination is made that view mapping successfully completed, CCDFVMP inserts a row into CPCPDRT using the temporarily saved data and the pointer to the view's location in the CCDFVMP's process virtual address space obtained in block 72 and then releases/deletes temporarily saved data(block 77, described above). Referring again to block 50, if a determination is made that a row is retrieved from CPCPDRT, then CCDFVMP compares types of pointing devices in stored in the temporarily saved data and stored in the retrieved row(block 52). Next, CCDFVMP passes to block 54 which illustrates determination, whether or not compared types of pointing devices are identical. If a determination is made that they are identical, CCDFVMP passes to block 56 which illustrates determination, whether or not the view identified by a pointer stored in the row retrieved from CPCPDRT exists. If a determination is made that the view does exist, CCDFVMP passes to block 77 described above. If a determination is made that the view does not exist, CPCPDRT querying EFMOT to retrieve a row, where type- of pointing device identify in columns(primary key) contain the data, which is identical to the type- of pointing device identifying data stored in the temporarily saved data(block 80).

Next, CCDFVMP verifies, whether a row is retrieved(block 82).

If no row is retrieved, CCDFVMP creates a file-mapping object of found conventional cursor driver file respective to the type- of pointing device identifying temporarily saved data and obtains a handle to the created file-mapping object(block 84). Next, CCDFVMP, using obtained handle, maps a view of the created file-mapped object into CCDFVMP's virtual address space and obtains a pointer to the view's location in the CCDFVMP's process virtual address space(block 86). Next, CCDFVMP updates a row from CPCPDRT(the columns identifying mapped view), using the obtained in block 86 pointer, identifying the mapped view of the respective file-mapping object (block 88). Next, CCDFVMP passes to block 76, described above. Referring again to block 82, if a determination is made that a row is retrieved from EFMOT, CCDFVMP is trying to map a view of the respective file-mapping object using the handle, stored in the retrieved row to obtain a pointer to the view's location in the CCDFVMP's process virtual address space(block 90). Next, CCDFVMP passes to block 91 which illustrates determination, whether or not the mapping has been failed, e.g., because the corresponding file-mapping object is no longer exist(e.g., due to computer's restart). If a determination is made that view mapping has been failed, CCDFVMP closes the handle of the corresponding file-mapping object(if its exist) deletes retrieved row from EFMOT(block 83) and passes to block 84, described above. If a determination is made that view's mapping successfully completed, CCDFVMP updates a row from CPCPDRT(the columns identifying mapped view), using the obtained in block 90 pointer, identifying the mapped view of the respective file-mapping object(block 92) and then releases/deletes temporarily saved data (block 77, described above). Referring again to block 54, if a determination is made that compared types of pointing devices are not identical, CCDFVMP passes to block 58 illustrates a determination of whether or not the view identified by a pointer stored in the row retrieved from CPCPDRT (in block 48) exists. If a determination is made that the view does not exist, CPCPDRT querying EFMOT to retrieve a row where type- of pointing device identify in columns(primary key) contain the data, which is identical to the type- of pointing device identifying data stored in the temporarily saved data(block 94).

Next, CCDFVMP verifies, whether a row is retrieved(block 96). If no row is retrieved, CCDFVMP creates a file-mapping object of found conventional cursor driver file respective to the type- of pointing device identifying temporarily saved data and obtains a handle to the created file-mapping object(block 98). Next, CCDFVMP, using obtained handle, maps a view of the created file-mapped object into CCDFVMP's virtual address space and obtains a pointer to the view's location in the CCDFVMP's process virtual address space(block 100). Next, CCDFVMP updates a row from CPCPDRT (the columns identifying mapped view and type- of pointing device identifying columns ), using the obtained in block 100 pointer, identifying the mapped view of the respective file-mapping object and using temporarily saved data(block 102).

Next, CCDFVMP passes to block 76, described above. Referring again to block 96, if a determination is made that a row is retrieved from EFMOT, CCDFVMP is trying to map a view of the respective file-mapping object using the handle, stored in the retrieved row to obtain a pointer to the view's location in the CCDFVMP's process virtual address space(block 104). Next, CCDFVMP passes to block 105 which illustrates determination, whether or not the mapping has been failed, e.g., because the corresponding file-mapping object is no longer exist(e.g., due to computer's restart). If a determination is made that view mapping has been failed, CCDFVMP closes the handle of the corresponding file-mapping object(if its exist), deletes retrieved row from EFMOT(block 99) and passes to block 98, described above. If a determination is made that view's mapping successfully completed, CCDFVMP updates a row from CPCPDRT(the columns identifying mapped view and type- of pointing devices identifying columns), using the obtained in block 100 pointer, identifying the mapped view of the respective file-mapping object(block 106) and then releases/deletes temporarily saved data (block 77, described above). Referring again to block 58, if a determination is made that the view identified by a pointer stored in the row retrieved from CPCPDRT (in block 48) does exist, then CCDFVMP unmaps the view(e.g. by the function “UnmapViewOfFile”) and passes to block 94, described above. Referring again to block 36, if a determination is made that no pointing devices are coupled to currently polled port, CCDFVMP temporarily save port-identifying data(block 38), next, verifies whether or not CCDFVMD exists(block 108). If a determination is made that CCDFVMD does not exist, CCDFVMP passes to block 77, described above. (It means that if no coupled pointing devices are identified upon poll cycle completion, and CCDFVMD was not created before poll cycle's beginning, CCDFVMD will not be created upon poll cycle completion as well). If a determination is made that CCDFVMD does exist, CCDFVMP querying CPCPDRT to retrieve a row where the port-identifying columns(primary key) contain the data identical to the port-identifying temporarily saved data (block 110). Next, CCDFVMP passes to block 112 which illustrates determination, whether or not a row is retrieved from CPCPDRT. If a determination is made that no row is retrieved CCDFVMP passes to block 77, described above. If a determination is made that a row is retrieved from CPCPDRT, CCDFVMP verifies whether or not the view exists, the view, identified by the pointer, stored in the view-identifying column in the retrieved from CPCPDRT row(block 114). If a determination is made that the view, identified by the pointer, stored in the view-identifying column in the retrieved from CPCPDRT row, does exist, CCDFVMP unmaps the view, e.g., by the function “UnmapViewOfFile”, using those pointer (block 116), next, CCDFVMP deletes the row retrieved(in block 110) from CPCPDRT(block 118) and then CCDFVMP passes to block 77, described above. If a determination is made that the view, identified by the pointer, stored in the view-identifying column in the retrieved from CPCPDRT row, does not exist, CCDFVMP deletes the row, retrieved(in block 110) from CPCPDRT(block 118) and then, CCDFVMP passes to block 77, described above.

Thus, upon loading, CCDFVMP provides automatic monitoring of computer's ports and creates/rebuilds/updates (when and where applicable) a set of views of the conventional cursor driver files(the views, located at CCDFVMP process's virtual address space), responsive to the detected changes in coupling/uncoupling of the pointing devices to the computer's ports.

As a result of each poll cycle, each coupled pointing device is provided with a mapped view of file-mapping object of the appropriate conventional cursor driver file for simultaneous communicating (one pointing device with one respective view) and creating multiple cursors, simultaneously controlled by the respective pointing devices(one pointing device—one port—one view—one cursor). Such matching (coupled pointing device—port—appropriate view) does not mean, that the pointing device will obligatory communicate with an instance (represented by a view) mapped against it. However, such matching guarantees a correct total balance of coupled pointing devices vs. the corresponding views, and, therefore, each view will simultaneously establish communication(will find a pair) with the appropriate coupled pointing device to serve those pointing device to create an independent cursor, the cursor, independently controlled by those pointing device. The pointing devices may be coupled to the computer via a Universal Serial Bus(USB), wirily or wirelessly(e.g., using Bluetooth technology via USB Bluetooth adapters).

In a more advanced implementation of the above-described embodiment, CCDFVMP intercepts, which view established communication with which pointing device, and re-match/re-assign views and coupled pointing devices according to established communication.

In another proposed embodiment(simplified), it is supposed that only one poll cycle is implemented upon CCDFVMP loading as a process and no DBMS/databases are involved. Upon loading in the computer's memory, CCDFVMP polls all computer's ports. For each polled port, if a pointing device is coupled to the port, CCDFVMP identifies the pointing device and obtains a handle to the file-mapping object of the appropriate conventional cursor driver file(e.g. as a return value of “CreateFileMapping” function, called by CCDFVMP to create a new file-mapping object of the appropriate conventional cursor driver file or in order to return a handle to the existing file-mapping object of the appropriate conventional cursor driver file). Using obtained handle, CCDFVMP maps a view of the corresponding file-mapped object to CCDFVMP's process's virtual address space(e.g., by the function “MapViewOfFile” or “MapViewOfFileEx”). As a result of the polling conducted, a set of views matched to the corresponding coupled pointing devices is created to serve simultaneously multiple pointing devices coupled to the computer to control respective independent cursors.

A person understanding this invention may now conceive of alternative structures and embodiments or variations of the above without departing from the spirit and scope of the invention. All thus which fall within the spirit and scope of the claims appended hereto are considered to be part of present invention. The description is there to be regarded as illustrative instead of restrictive in the present invention. Furthermore, in the description, Win32 file-mapping functions are used. Those skilled in the art will understand that similar functions and objects could be used in any OS that includes file mapping feature.

I claim:

1. A computer program loaded into computer memory as a process, said computer program allows to support simultaneously a plurality of cursors, displayed on at least one display coupled to said computer, each cursor of said plurality of cursors is independently controlled by a respective pointing device of a plurality of pointing devices coupled to said computer via a respective communication port of said computer, wherein said computer program: i) automatically polls communication ports of said computer in order to determine for each communication port if a pointing device is coupled to said computer via the communication port; ii) if a pointing device is coupled: to said computer via the communication port, identifies a type of the pointing device; iii) creates a file-mapping object of a conventional cursor driver file that corresponds to the type of the identified pointing device when the file-mapping object does not exist; iv) maps a view of the file-mapping object into the virtual address space of the process of said loaded computer program; and upon completion of the polling v) allows simultaneous communication between each of the identified pointing device with any one of the corresponding mapped views to control independently the corresponding cursor of said plurality of cursors.

2. A computer program as claimed in claim 1, wherein said plurality of pointing devices are coupled to said computer via Universal Serial Bus.

3. A computer program loaded into computer memory as a process, said computer program periodically, cycle after cycle with a time delay between each two consecutive cycles, monitors communication ports of said computer in order to allow during each said time delay to support simultaneously a plurality of cursors displayed on at least one display coupled to said computer, each cursor of said plurality of cursors is independently controlled by a respective pointing device of a plurality of pointing devices identified during the corresponding cycle and coupled to said computer via a respective communication port of said computer, wherein said computer program: a) load a configuration file comprising said time delay definition; b) creates Conventional Cursor Driver Files' Views Management Database(CCDFVMD) if said CCDFVMD does not exist, said CCDFVMD comprising Communication Ports—Coupled Pointing Devices Relations Table (CPCPDRT), said CPCPDRT comprising at least one column to identify a communication port, at least one column to identify a type of the pointing device coupled to the computer via the communication port and a column comprising a pointer to the location in said process's virtual address space of a mapped view of a file-mapping object of the conventional cursor driver file corresponding to the pointing device;
c) connects to said CCDFVMD;
d) executes said cycles, during each said cycle:
i) automatically polls communication ports of said computer in order to determine for each communication port if a pointing device is coupled to said computer via the communication port; ii) if a pointing device is coupled to said computer via the communication port, identifies a type of the pointing device; iii) temporarily, until the beginning of the next port polling, saves the data identifying a type of the pointing device and the communication port;
iv) issues a query on CPCPDRT to retrieve a row matching to the communication port, if a row is retrieved, compares said temporarily saved type of the pointing device with a type of pointing device contained in the corresponding column of the retrieved row, if said compared types are identical, determines if a view, identified by a pointer contained in the retrieved row exists, if the view exists, deletes said temporarily saved data and polls next communication port or complete the cycle; if the view does not exist, obtains a handle to a file-mapping object of a conventional cursor driver file corresponding to the temporarily saved type of the pointing device, using the obtained handle maps the corresponding view, updates a pointer identifying the view in the corresponding column in the retrieved row and polls next communication port or complete the cycle; if said compared types are different, unmap the corresponding view, if the view exists, using a pointer identifying the view and contained in the retrieved row, obtains a handle to a file-mapping object of a conventional cursor driver file corresponding to the temporarily saved type of the pointing device, using the obtained handle, maps the corresponding view, updates a pointer identifying the view in the corresponding column in the retrieved row, deletes said temporarily saved data and polls next communication port or complete the cycle; if no rows retrieved, obtains a handle to a file-mapping object of a conventional cursor driver file corresponding to the temporarily saved type of the pointing device, using the obtained handle, maps the corresponding view, obtains the corresponding pointer, identifying the view, inserts a row into CPCPDRT, the row comprising: temporarily saved data, identifying the type of the pointing device, the communication port and the pointer, identifying the view, deletes said temporarily saved data and polls next communication port or complete the cycle;
(v) if no pointing device is coupled to said computer via the communication port, temporarily, until the beginning of the next port polling, saves the data identifying the communication port; (vi) issues a query on CPCPDRT to retrieve a row matching to the communication port, if a row is retrieved, unmaps the corresponding view if the view exists using a pointer identifying the view and contained in the retrieved row, deletes the retrieved row, deletes said temporarily saved data and polls next communication port or complete the cycle, if no rows retrieved, deletes said temporarily saved data and polls next communication port or complete the cycle; and
vi) allows simultaneous communication between each of the identified pointing device with any one of the corresponding mapped views to control independently the corresponding cursor of said plurality of cursors.

4. The computer program as claimed in claim 3, wherein said CCDFVMD further comprising Existing File-Mapped Objects Table(EFMOT), said EFMOT comprising at least one column to identify the type of the pointing device coupled to the computer via the communication port and a column comprising a handle to file-mapping object corresponding to the type of the pointing device and wherein to obtain the handle said computer program:
a)issues a query on EFMOT to retrieve a row matching to the temporarily saved type of the pointing device, if no rows retrieved, creates a file-mapping object of a conventional cursor driver file corresponding to the temporarily saved type of the pointing device, obtains the handle to the the file-mapping object, inserts a row into EFMOT, the row comprising: the temporarily saved type of the pointing device and obtained handle to the file-mapping object, if a row is retrieved, obtains the corresponding handle contained in the corresponding column of the row.

5. A computer program claimed in claim 4, wherein said computer program after completion of each said cycle: i) issues a query to retrieve rows from EFMOT and ii) for each row retrieved from EFMOT: issues a query to retrieve matching rows from CPCPDRT, if no matching rows retrieved from CPCPDRT, deletes the corresponding row retrieved from EFMOT.

6. A computer program as claimed in claim 5, wherein pointing devices of said plurality of pointing devices are coupled to said computer via Universal Serial Bus.
